(19) United States
(12) Patent Application Publication
(10) Pub. No.: US 2021/0253306 A1
(43) Pub. Date: Aug. 19, 2021

(54) CLOSURE WITH WOOD FILLER

(71) Applicant: Closure Systems International Inc., Indianapolis, IN (US)

(72) Inventors: Richard Peters, Crawfordsville, IN (US); Jeremy Morin, Zionsville, IN (US)

(21) Appl. No.: 17/167,809

(22) Filed: Feb. 4, 2021

Related U.S. Application Data
(60) Provisional application No. 62/977,844, filed on Feb. 18, 2020.

(51) Int. Cl. B65D 41/34; B65D 41/04; B65D 41/48

(52) U.S. Cl. CPC B65D 41/3428; B65D 41/485; B65D 41/0471; B65D 41/0414

(57) ABSTRACT

A one-piece closure includes first and second closure portions. The first closure portion includes a top wall portion and an annular skirt portion depending from the top wall portion. The annular skirt portion includes an internal thread formation for mating engagement with an external thread formation of a container. The second closure portion includes a tamper-evident band. The tamper-evident band depends from and is partially detachably connected to the annular skirt portion by a first frangible connection. The closure includes polymeric material and wood filler.

### CROSS-REFERENCE TO RELATED APPLICATIONS

This application claims priority to and benefit of U.S. Provisional Patent Application No. 62/977,844 filed Feb. 18, 2020, which is hereby incorporated by reference herein in its entirety.

### FIELD OF THE INVENTION

The present invention relates generally to a polymeric closure for a package. More specifically, the present invention relates to a polymeric closure with wood filler.

### BACKGROUND OF THE INVENTION

Polymeric closures have been used in many applications over the years in conjunction with containers. One type of polymeric closure that has been used with containers is a tamper-evident polymeric closure. Tamper-evident closures are used to prevent or inhibit tampering by providing a visible indication to a user if the closure has been opened. This visual indication typically divides the closure into two separate components after the tamper-evident feature has been broken. The top portion of the closure is then removed from the container to gain access to the contents of the containers. The polymeric materials used to form closures tend to be expensive when using the quantity of material to form the needed number of closures.

It would be desirable to provide a more cost-effective closure that has tamper-evident features, while still performing all of the desirable properties of a closure. It would also be a desirable for form closures using biosource materials.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to one embodiment, a one-piece closure includes first and second closure portions. The first closure portion includes a top wall portion and an annular skirt portion depending from the top wall portion. The annular skirt portion includes an internal thread formation for mating engagement with an external thread formation of a container. The second closure portion includes a tamper-evident band. The tamper-evident band depends from and is partially detachably connected to the annular skirt portion by a first frangible connection. The closure includes polymeric material and wood filler.

According to another embodiment, a one-piece closure includes first and second closure portions. The first closure portion includes a top wall portion and an annular skirt portion depending from the top wall portion. The annular skirt portion includes an internal thread formation for mating engagement with an external thread formation of a container. The second closure portion includes a tamper-evident band. The tamper-evident band depends from and is partially detachably connected to the annular skirt portion by a first frangible connection. The closure includes polymeric material and wood filler.

### BRIEF DESCRIPTION OF THE DRAWINGS

Other advantages of the invention will become apparent upon reading the following detailed description and upon reference to the drawings in which:

FIG. 1A is a top perspective view of a closure in a closed position according to one embodiment.

FIG. 1B is a cross-sectional view taken generally along line 1B-1B in FIG. 1A.

FIG. 1C is a side view of the closure of FIG. 1A.

FIG. 2 is a top perspective view of the closure of FIG. 1A in an open position.

FIG. 3A is a top perspective view of a package including the closure of FIG. 1A and a container in a closed position according to one embodiment.

FIG. 3B is a cross-sectional view taken generally along line 3B-3B in FIG. 3A.

FIG. 3C is a side view of the closure of FIG. 3A.

FIG. 4A is a perspective top view of a closure according to a further embodiment.

FIG. 4B is a bottom view of the closure of FIG. 4A.

FIG. 4C is a cross-sectional view of the closure of FIG. 4B taken generally along line 4C-4C.

FIG. 5 is a cross-sectional view of the closure of FIGS. 4A, 4B in threaded connection with a container according to one embodiment.

FIG. 6A is a top perspective view of a flip-top closure in a closed position according to one embodiment.

FIG. 6B is a top view of the flip-top closure of FIG. 6A.

FIG. 6C is a cross-sectional view taken generally along line 6C-6C in FIG. 6B.

FIG. 7 is a top perspective view of a package including the flip-top closure of FIG. 6A and a container in a closed position according to one embodiment.

FIG. 8A is a bottom perspective view of a polymeric closure (shown for clarity without a polymeric liner and disc) according to one embodiment of the invention.

FIG. 8B is a top perspective view of the polymeric closure of FIG. 8A.

FIG. 9 is a cross-sectional view of the closure of FIGS. 8A and 8B (including the polymeric liner and disc) in threaded connection with a container according to one embodiment of the invention.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various embodiments are described with reference to the attached figures, where like reference numerals are used throughout the figures to designate similar or equivalent elements. The figures are not drawn to scale and are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details, or with other methods. In other instances, well-known structures or operations are not shown in detail to avoid obscuring the invention. The various embodiments are not limited by the illustrated ordering of acts or events, as some acts may occur in different orders and/or concurrently with other acts or events. Furthermore, not all illustrated acts or events are required to implement a methodology in accordance with the present invention.

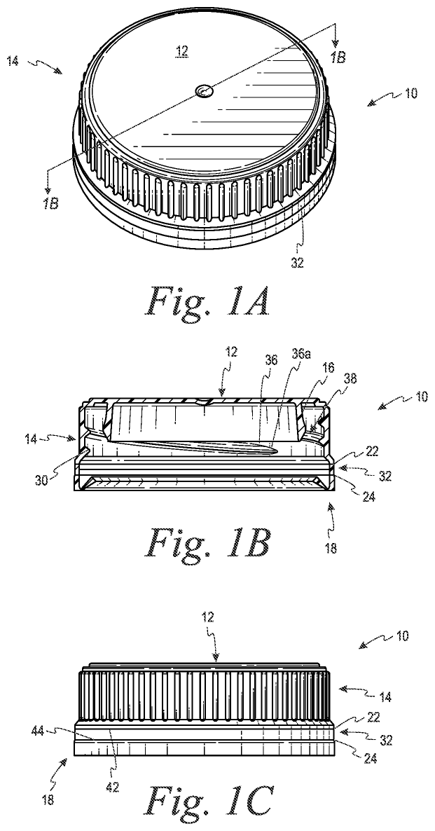

FIGS. 1A-C and 2 illustrate a polymeric closure 10 according to one embodiment of the present invention. The closures are configured to be placed on a container or bottle that contain product. The product is typically a liquid product, but also may be a solid product or a combination of a liquid and solid product. The polymeric closure 10 of FIGS. 1A-C and 2 is a one-piece closure assembly. The polymeric closure 10 is generally cylindrically shaped.

Referring still to FIGS. 1A-C and 2, the polymeric closure 10 includes a polymeric top wall portion 12, a polymeric annular skirt portion 14 that depends from the polymeric top wall portion 12, a polymeric continuous plug seal 16 (FIG. 1B), and a tamper-evident band 18 (FIG. 1B). The top wall portion 12 extends across the entire top of the closure without any openings.

The polymeric annular skirt portion 14 includes a second frangible connection 22 that partially detachably connects to a first section and a second section of the polymeric annular skirt portion 14. The polymeric annular skirt portion 14 of FIG. 1B also includes an internal thread formation 30. The internal thread formation includes a plurality of leads in one embodiment. The internal thread formation 30 is configured for mating engagement with a corresponding external thread formation of a neck portion of a container. The internal thread formation 30 depicted in FIG. 1B includes a first closure lead 36 and a second closure lead 38. It is contemplated that the internal thread formation may be continuous in another embodiment.

The first closure lead 36 begins near the polymeric top wall portion 12 at a first position (not shown in FIG. 1B) and extends in a helical fashion to a second position 36a closer to the tamper-evident band 18. Similarly, the second closure lead 38 begins near the polymeric top wall portion 12 at a first position (not shown in FIG. 1B) and extends in a helical fashion to a second position (not shown in FIG. 1B) closer to the tamper-evident band 18. The first and second closure leads 36, 38 are referred collectively as a double lead closure thread. Each of the first and second closure leads 36, 38 is continuous. The first positions of the first and second closure leads 36, 38 are located roughly 180 degrees apart from each other and, thus, begin on generally opposing sides of the closure 10.

It is contemplated that the first and second closure leads may be discontinuous. It is also contemplated that the internal thread formation of the closure may differ from a helical thread formation. It is also contemplated that other internal thread formations may be used in the closure.

The polymeric continuous plug seal 16 of FIG. 1B depends from the polymeric top wall portion 12. The continuous plug seal 16 is spaced from an interior surface of the polymeric annular skirt portion 14. It is contemplated that other sealing methods may be used in sealing the closure.

Referring specifically to FIG. 1B, the polymeric tamper-evident band 18 of the closure 10 is located at the bottom thereof (i.e., an end opposite of the polymeric top wall portion 12). The tamper-evident band 18 depends from and is partially detachably connected to the annular skirt portion 14 by the first frangible connection 24. The tamper-evident band 18 works in conjunction with the container to indicate to a user that the contents of the container may have been accessed. More specifically, the tamper-evident band 18 is designed to partially separate from the annular skirt portion 14 if a user opens the package and gains access to the container.

The first and second frangible connections 24, 22 may be formed by molded-in-bridges in one embodiment. The molded-in-bridges are typically formed using a feature in the mold. In another embodiment, the polymeric tamper-evident band may be formed using scoring or scored lines, notches, leaders, nicks or other lines of weaknesses.

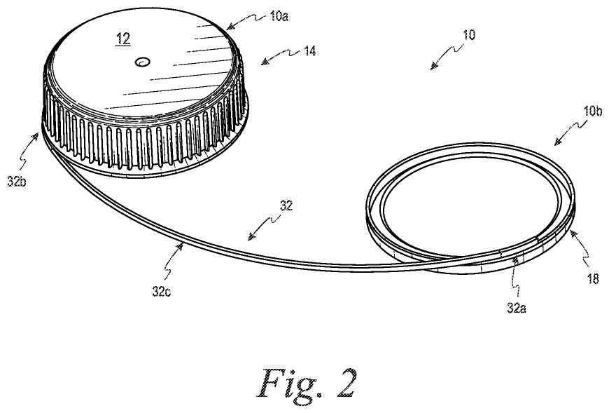

When the first and second frangible connections 24, 22 are broken, a tether 32 is exposed as shown, for example, in FIG. 2. The tether 32 is attached to a portion of the second closure portion 10b (including the tamper-evident band 18) and a portion of the first closure portion or main body 10a (including the annular skirt portion 14 and the polymeric top wall portion 12). The tether 32 assists in maintaining the closure 10 as a one-piece assembly after the first and second frangible connections 24, 22 have been broken.

As shown in FIG. 2, the tether 32 includes attached portions 32a, 32b and also includes an unattached portion 32c that is located between the attached portions 32a, 32b. When the internal thread formation of the first closure portion is not in mating engagement with the external thread formation of the container, the first closure portion 10a is adapted to be spaced away from the second closure portion 10b via the unattached tether portion 32c. One non-limiting example of the same is shown in FIG. 2 with only the closure 10. The length of the attached and unattached portions of the tether may vary from that shown in FIG. 2.

The tether 32 is of a length that assists in spacing apart the first closure portion 10a from the second closure portion 10b. To assist in eliminating or reducing the chances of the first closure portion 10a from interfering with a user while, for example, drinking the contents of a container, the unattached portion 32c of the tether 32 extends greater than about 300 degrees around the circumference of the closure in one embodiment. By having the unattached portion of the tether extending greater than about 300 degrees around the circumference of the closure, the distance of the first closure portion 10a from the neck of the container is increased. In other embodiments, the unattached portion of the tether desirably extends greater than about 320 or about 330 degrees around the circumference of the closure. In a further embodiment, the unattached portion of the tether extends greater than about 340 degrees around the circumference of the closure.

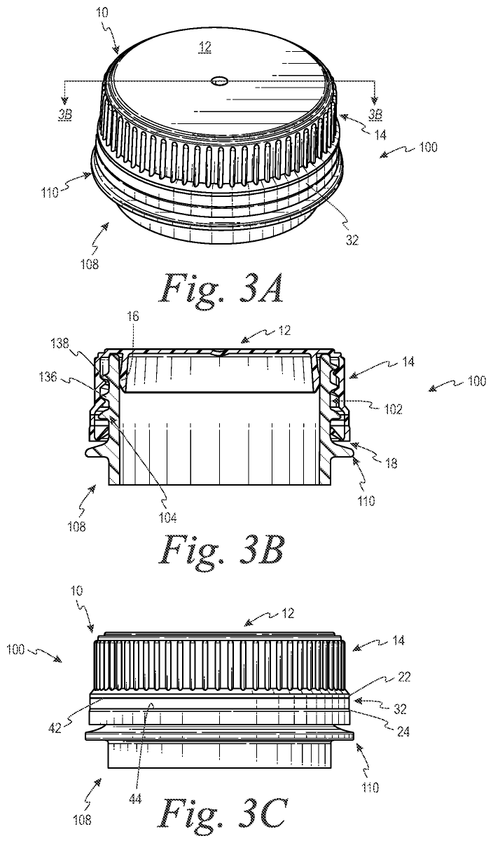

One non-limiting example of a closure and a container forming a package is shown and discussed in conjunction with FIGS. 3A-3C.

The closure 10 may be used with a container 108 used to form a package 100 of FIGS. 3A-3C. A portion of the container 108 is shown in FIGS. 3A-3C and includes a neck portion 102 that defines an opening. The neck portion 102 of the container 108 includes an external thread formation 104 and a continuous outer ring 110. The external thread formation 104 includes a first finish lead 136 and a second finish lead 138 (FIG. 3B). The external thread formation 104 (finish leads 136, 138) engages with the corresponding internal thread formation 30 (closure leads 36, 38) to seal the package 100.

The first finish lead 136 begins near the open end of the container 108 and extends in a helical fashion to a second position that is closer to the closed end of the container. Similarly, the second finish lead 138 starts closer to the open end of the container 108 and extends in a helical fashion to a second position that is closer to the closed end of the container. Each of the first and second finish leads 136, 138 is continuous. The first positions of the first and second finish leads 136, 138 are located roughly 180 degrees apart from each other and, thus, begin on opposing sides of the neck 102 of the container 108. When opening the container 108, the first closure lead 36 is desirably in contact with the first finish lead 136 and the second closure lead 38 is desirably in contact with the second finish lead 138. It is contemplated that the external thread formation of the container may have discontinuous leads.

It is contemplated that the external thread formation of the container may be different than that disclosed with respect to container 108.

The continuous outer ring 110 assists in positioning the tamper-evident band 18 when the first closure portion 10a is unthreaded from the neck 102 of the container 108 by the breaking of the first and second frangible connections 24, 22.

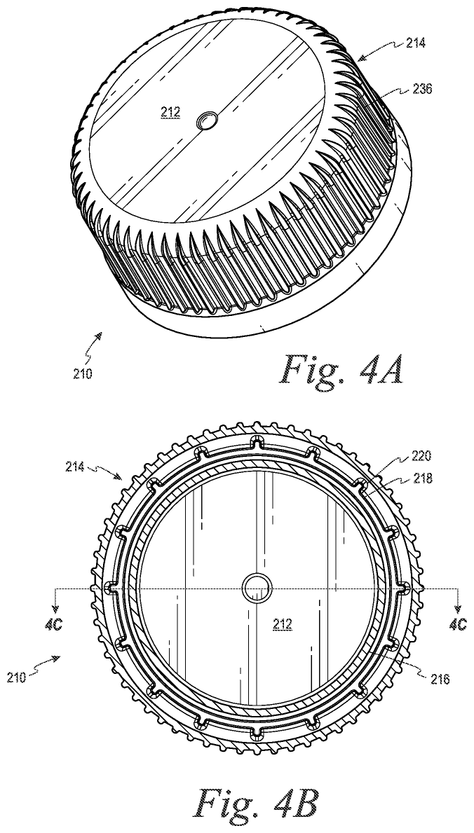

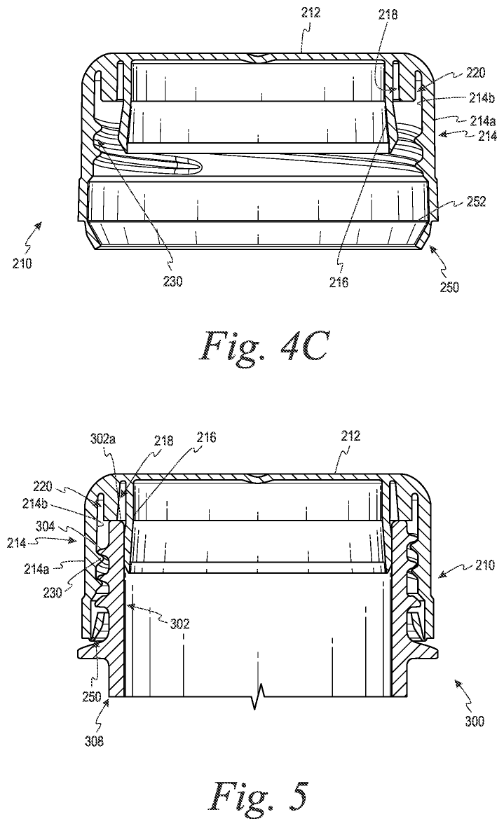

According to another embodiment, the closure may be formed without a tether as described above with closure 10. One non-limiting example is shown in with closure 210 in FIGS. 4A-4C and 5. The closure 210 of FIGS. 4A-4C and 5 is a one-piece closure and is a generally cylindrical shape. The polymeric closure 210 includes a polymeric top wall portion 212, a polymeric annular skirt portion 214 that depends from the polymeric top wall portion 212, a polymeric continuous plug seal 216, and a polymeric top seal 218 that includes a plurality of sealing gussets 220. The top wall portion 212 of FIG. 4A extends across the entire top of the closure without any openings in this embodiment.

The polymeric annular skirt portion 214 of FIGS. 4C and 5 includes an internal thread formation 230. The polymeric annular skirt portion 214 includes an exterior surface 214a and an interior surface 214b. The internal thread formation 230 is configured for mating engagement with a corresponding external thread formation of a neck portion of a container. The internal thread formation of the closure may include continuous or discontinuous thread segments, and may include single or multiple leads or threads. Thus, it is contemplated that different thread formations may be used in the closure. One non-limiting example of an internal thread formation is a helical thread formation.

The polymeric continuous plug seal 216 depends from the polymeric top wall portion 212 as shown in FIG. 4C. The continuous plug seal 216 works in conjunction with the finish of the container to form a seal as will be discussed below in conjunction with FIG. 5. The continuous plug seal 216 of FIG. 4C is spaced from and is not directly connected to the polymeric annular skirt portion 214. By being disconnected from the annular skirt portion 214, any impact to the exterior surface 214a of the polymeric annular skirt portion 214 will have less risk of being transferred to the finish of the container, which can potentially disturb the seal between the continuous plug seal 216 and the finish. Such a disturbance can cause a loss in product integrity.

Referring back to FIGS. 4A-4C, the top seal 218 includes the plurality of sealing gussets 220 that are integrally connected to each other. The top seal 218 including the plurality of gussets 220 depends from the top wall portion 212. The top seal 218 is shown as being continuous in FIG. 4B and is in the form of a generally circular ring. Both the top seal 218 and the plurality of gussets 220 are spaced from and located between the continuous plug seal 216 and the polymeric annular skirt portion 214.

The top seal 218 including the plurality of gussets 220 assists in providing a positive stop when the finish of the container and the closure are being threaded with each other. Thus, the top seal 218 and the plurality of gussets 220 assist in positioning the finish of the container when the closure is being threaded onto the finish.

The top seal 218 including the plurality of gussets 220 is designed to add height in selected areas to lengthen the closure 210, which assists in providing gripability to the user. The top seal 218 and the plurality of gussets 220 lengthen the closure 220 without significantly increasing the weight of the closure. The plurality of sealing gussets 220 also adds support and a strengthening structure to the closure 210.

The combination of the top plug seal 218 and the plurality of gussets 220 form an extended seal of the closure 210. The extended seal typically forms a physical, hermetic seal with the finish of the container. In another embodiment, the extended seal contacts the finish of the container, but does not form a physical, hermetic seal.

The closure 210 as shown in FIG. 4A includes a plurality of knurls 236 formed on the annular skirt portion 214. The plurality of knurls 236 assists the user in gripping the closure during the opening and closing of the closure from the container.

The closure may also include a polymeric tamper-evident feature. For example, the closure 210 includes a polymeric tamper-evident band 250 (FIG. 4C) located at the bottom thereof (i.e., an end opposite of the polymeric top wall portion 212). The tamper-evident band 250 depends from and is at least partially detachably connected to the polymeric annular skirt portion 214 by a frangible connection 252. The tamper-evident band 250 works in conjunction with the container to indicate to a user that the contents of the container may have been accessed.

The polymeric tamper-evident band may be formed by molded-in-bridges in one embodiment. The molded-in-bridges are typically formed using a feature in the mold. In another embodiment, the polymeric tamper-evident band may be formed using scoring or scored lines, notches, leaders, or other lines of weaknesses.

The tamper-evident band 250 is in a reversed orientation in FIG. 4C. This is a common orientation when the closure is removed from a mold and allows the closure to be ejected more easily from the closure-forming tooling. The tamper-evident band is later folded from the reversed orientation into a functional orientation, which is shown and discussed below with respect to FIG. 5.

The closures of the present invention, including the closure 210, may be used with a container 308 to form a package 300 of FIG. 5. A portion of the container 308 is shown in FIG. 5 and includes the neck portion 302 that defines an opening. The neck portion 302 of the container 308 includes an external thread formation 304. The external thread formation 304 of the container 308 engages with the corresponding internal thread formation 230 of the closure 210 to seal the package 300. The external thread formation of the container may include continuous or discontinuous thread segments, and may include single or multiple threads. One non-limiting example of an external thread formation of the container is a helical thread formation.

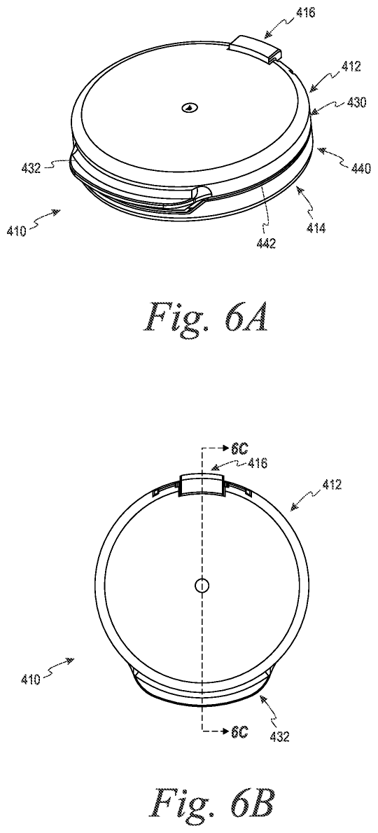

According to another embodiment, a flip-top closure 410 may be used in another embodiment. Referring to FIGS. 6A-6C, the flip-top closure 410 is shown. The flip-top closure 410 is configured to assist in keeping it with the container so as to reduce environmental waste, while still providing a desirable tamper-evident feature and maintaining the closure in an open position when accessing the contents of the container.

Referring still to FIGS. 6A-6C, the flip-top closure 410 includes a first closure portion or lid 412 and a second closure portion or base 414. The flip-top closure 410 is a one-piece closure. The first closure portion 412 and the second closure portion 414 are connected via a hinge 416. As shown best in FIG. 6C, the first closure portion 412 includes a polymeric top wall portion 422, a polymeric continuous plug seal 424, a polymeric top stop 426 and a polymeric outer seal 428, a polymeric annular skirt portion 430 and a prying tab 432. The second closure portion 414 includes a polymeric tamper-evident band 440.

As shown in FIG. 6C, the polymeric continuous plug seal 424 depends from the polymeric top wall portion 422 and provides an inner sealing mechanism. The continuous plug seal 424 is spaced from an interior surface 430a of the polymeric annular skirt portion 430 when the flip-top closure 410 is in a closed position. In one embodiment, the polymeric continuous plug seal may include interlocking bumps. The polymeric continuous plug seal 424 includes a first end 424a and a second end 424b. The second end 244b is located farther away from the polymeric top wall portion 422 than the first end 424a. The polymeric continuous plug seal 424 includes at least one interlocking bump 424c at a second end 424b to assist in snapping the first closure portion 412 into a container.

The polymeric top stop 426 depends from the polymeric top wall portion 422. The polymeric top stop 426 is spaced from the interior surface 430a of the polymeric annular skirt portion 430 when the flip-top closure 410 is in a closed position as shown in FIG. 6C. The polymeric top seal 426 assists in providing a positive stop when the finish of the container and the closure are locked together. Thus, the top stop 426 assists in positioning the finish of the container and the closure when being placed together. The top stop 426 is typically continuous. It is contemplated that the top stop may be discontinuous in another embodiment.

The polymeric outer seal 428 depends from the polymeric top wall portion 422 and provides an outer sealing mechanism. The polymeric outer seal 428 is spaced from the interior surface 430a of the polymeric annular skirt portion 430 when the flip-top closure 410 is in a closed position as shown in FIG. 6C.

Referring back to FIGS. 6A-6C, the polymeric tamper-evident band 440 of the closure 410 is located at the bottom thereof (i.e., an end opposite of the polymeric top wall portion 422). The tamper-evident band 440 works in conjunction with the container to indicate to a user that the contents of the container may have been accessed. More specifically, the tamper-evident band 440 is designed to partially separate from the annular skirt portion 430 if a user opens the package by flipping the flip-top closure via the hinge 416.

The first closure portion 412 and the second closure portion 414 are attached by the hinge 416. The hinge 146 assists in moving the flip-top closure 10 between an open position and a closed position. The hinge 16 is shown in FIGS. 6A-6C in the closed position. It is most desirable for the hinge 416 to flip or rotate at least about 200 or about 215 degrees or even more desirably at least about 225 or about 235 degrees from a closed position to an open position. The hinge 416 may flip or rotate up to about 215 or about 225 degrees. It is desirable for the hinge 416 to flip or rotate up to about 235 degrees. The hinge typically flips or rotates from about 190 to about 235 degrees and, more specifically, from about 190 to about 225 degrees.

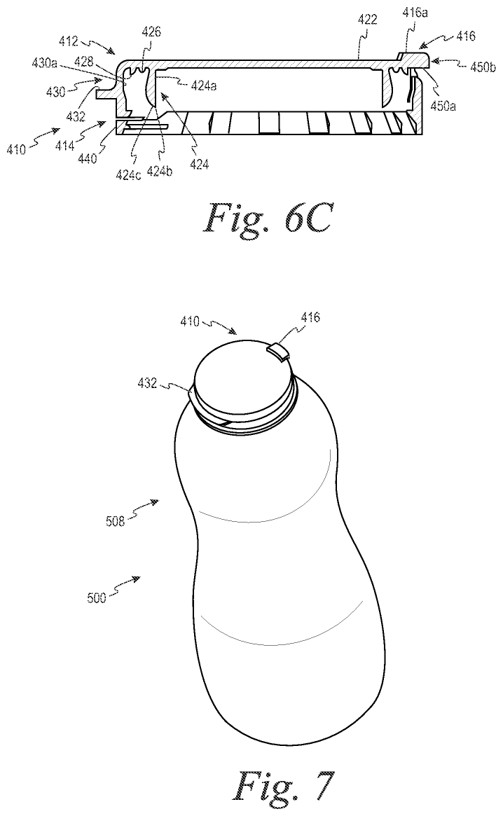

One non-limiting example of a flip-top closure and a container forming a package is shown and discussed in conjunction with FIG. 7. The closure 410 may be used with a container 508 used to form a package 500 of FIG. 7. The container 508 includes a neck portion 502 that defines an opening.

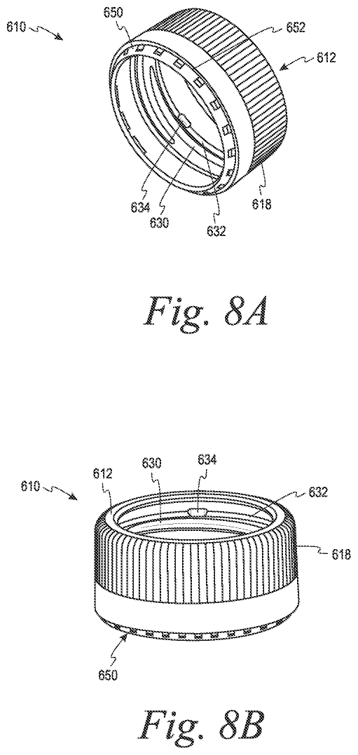

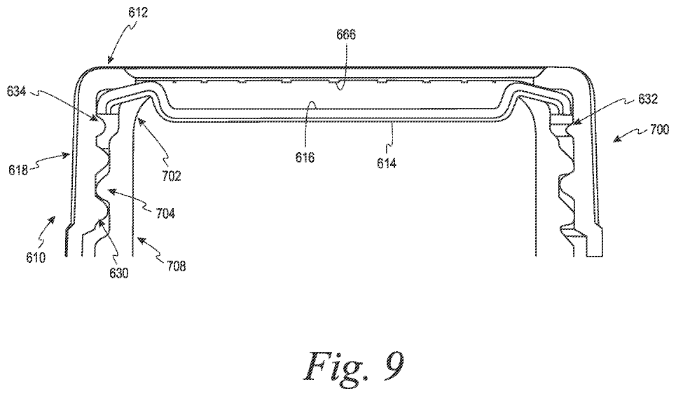

In another embodiment, the polymeric closure may be a two-piece closure. For example, referring to FIGS. 8A, 8B and 9, a polymeric closure 610 is shown. For clarity, the polymeric closure in FIGS. 8A, 8B has been shown without a polymeric liner and a polymeric disc.

Referring to FIGS. 8A, 8B and 9, a polymeric closure 610 includes a polymeric top wall portion 612, a polymeric liner 614, a polymeric disc 616 and a polymeric annular skirt portion 618 that depends from the polymeric top wall portion 612. The top wall portion 612 is in a donut-shaped configuration. It is contemplated that the top wall portion may extend across the entire top of the closure without any openings. The polymeric disc 616 is located between the polymeric top wall portion 612 and the polymeric liner 614.

The polymeric annular skirt portion 618 of FIGS. 8A, 8B and 9 includes an internal thread formation 630, an internal bead 632, and an internal prying projection 634. It is contemplated that the internal prying projection 634 may be omitted in another embodiment of this closure.

The internal thread formation 630 is configured for mating engagement with a corresponding external thread formation of a neck portion of a container. The internal thread formation of the closure may include continuous or discontinuous thread segments, and may include single or multiple threads. Thus, it is contemplated that different threads formations may be used in the closure. One non-limited example of an internal thread formation is a helical thread formation.

The internal bead 632 of FIGS. 8A, 8B and 9 assists in maintaining the polymeric disc 616 and the polymeric liner 614 in a proper position within the closure 610. The internal bead 632 extends generally circumferentially around an interior of the closure 610 in a continuous manner. It is contemplated that the internal bead may be discontinuous. It also contemplated that the internal bead may include a plurality of segments.

It is contemplated that the polymeric disc and polymeric liner may maintain their position by mechanisms other than an internal bead such as an internal thread formation that includes multiple threads.

The internal prying projection assists in removing the closure from the neck portion of the container. The internal prying projection is a mechanism for breaking a sealing adhesion formed between the polymeric liner and the container after processing (e.g., high-temperature processing such as retort processing). To assist in removing the closure from a container, at least a portion of the internal prying projection is typically located above the internal thread formation (i.e., closer to the polymeric top wall portion 612). The internal prying projection 634 is located adjacent to or in contact with the internal bead 632. In this embodiment, as best shown in FIG. 9, the internal prying projection 634 extends farther inwardly toward a center of the interior of the closure 610 than the internal bead 632.

The internal prying projection 634 is shown as a single projection. It is contemplated that the closure may include a plurality of internal prying projections to assist in removing the closure from the container.

The closure may also include a polymeric tamper-evident feature. For example, the closure 610 includes a polymeric tamper-evident band 650 (FIGS. 8A, 8B) located at the bottom thereof (i.e., an end opposite of polymeric top wall portion 612). The tamper-evident band 650 depends from and at least partially detachably connected to the annular skirt portion 618 by a frangible connection 652. The tamper-evident band 650 works in conjunction with the container to indicate to a user that the contents of the container may have been accessed. More specifically, the tamper-evident band 650 is designed to separate from the annular skirt portion 18 if a user starts to open the package and gain access to the container.

The closures of the present invention may be used with a container 708 used to form a package 700 of FIG. 9. A portion of the container 708 is shown in FIG. 7 and includes a neck portion 702 that defines an opening. The neck portion 702 of the container 708 includes an external thread formation 704. The external thread formation 704 of the container 708 engages with the corresponding internal thread formation 630 of the closure 610 to seal the package 700. The external thread formation of the container may include continuous or discontinuous thread segments, and may include single or multiple threads. Thus, it is contemplated that different threads formations may be used in the container. One non-limited example of an external thread formation is a helical thread formation.

The closures of the present invention may include an oxygen-scavenger material. This oxygen-scavenger material may be distributed within the closure or may be a separate layer. The oxygen-scavenger material may be any material that assists in removing oxygen within the container, while having little or no effect on the contents within the container.

Alternatively, or in addition to, the closures may include an oxygen-barrier material. The oxygen-barrier material may be added as a separate layer or may be integrated within the closure itself. The oxygen-barrier materials assist in preventing or inhibiting oxygen from entering the container through the closure. These materials may include, but are not limited to, ethylene vinyl alcohol (EVOH). It is contemplated that other oxygen-barrier materials may be used in the closure.

In one embodiment, the closures of the present invention, including the top wall portion and the annular skirt portion, comprise polymeric material and wood filler. Wood fillers are one example of a biosource material that can be used in forming the closures. This is beneficial in that less petroleum-based materials are needed in forming the closure.

The polymeric material is typically an olefin (e.g., polyethylene (PE), polypropylene (PP)), PET or blends thereof. Non-limiting examples of polyethylenes that may be used are high density polyethylene (HDPE), low density polyethylene (LDPE), linear low density polyethylene (LLDPE) and metallocene-catalyzed LLDPE (mLLDPE).

The wood filler for forming the closure, including the top wall portion and the annular skirt portion, may be made of, for example, wood flour, wood dust or combinations thereof. For use in forming the closures, the length of the wood dust particles is generally from about 0.02 mm to about 1 mm. More specifically, the length of the wood dust particles is typically from about 0.05 mm to about 0.5 mm, and from about 0.07 mm to about 0.3 mm. The length of the wood flour particles is also generally from about 0.02 mm to about 1 mm. More specifically, the length of the wood flour particles is typically from about 0.05 mm to about 0.5 mm, and from about 0.07 mm to about 0.3 mm.

The length of the wood dust or flour particles to be used in the closures is typically controlled by a sieve or screen in one embodiment. This could be performed in an on-line or an off-line process. The sieve or screen will catch or trap lengths of wood dust or flour particles greater than the greatest distance across the square-shaped areas formed within the sieve or screen. The wood dust or wood flour would typically need further processing such as drying to remove any contained moisture therein.

The most common measurement unit of sieves or screens is mesh size. The mesh size of the sieves or screens of wood dust or wood flour is typically from about 18 to about 400. A mesh size of 18, for example, will have 18 openings in one linear inch. In other embodiments, the mesh size for the wood dust of wood flour will be from about 20 to about 200, or from about 30 to about 100. In further embodiments, the mesh size for the wood dust of wood flour is from about 40 to about 100, or from about 50 to about 80.

The wood fillers may be comprised of softwood, hardwood or combinations thereof. Some non-limiting examples include, but are not limited to, maple, pine, cedar, cherry and oak. It is contemplated that other types of wood may be used in forming the wood filler.

The closure generally has from about 25 to about 99 wt. % polymeric material and about 1 to about 75 wt. % wood filler. More specifically, the closure generally has from about 50 to about 95 wt. % polymeric material and about 5 to about 50 wt. % wood filler. The closure is from about 50 to about 90 wt. % polymeric material and about 10 to about 50 wt. % wood filler.

More specifically, the closure has from about 60 to about 95 wt. % polymeric material and about 5 to about 40 wt. % wood filler. The closure has from about 60 to about 90 wt. % polymeric material and about 10 to about 40 wt. % wood filler. More specifically, the closure has from about 70 to about 95 wt. % polymeric material and about 5 to about 30 wt. % wood filler. The closure has from about 70 to about 90 wt. % polymeric material and about 10 to about 30 wt. % wood filler. The closure has from about 75 to about 90 wt. % polymeric material and about 10 to about 25 wt. % wood filler. The closure typically has from about 80 to about 90 wt. % polymeric material and about 10 to about 20 wt. % wood filler.

In addition to the polymeric material and the wood filler, additional additives may be used in forming the closures of the present invention. One additive that may be used in an adhesion promoter or compatibilizer to assist in improving the compatibility of the polymeric material and wood filler. One non-limiting example of an adhesion promoter includes, but is not limited to, maleic anhydride modified polyolefin. Another additive that may be added to the polymeric material and the wood filler is a biocide, which assist in preventing or inhibiting the wood filler from degrading. Non-limiting examples of biocides include, but are not limited to, antimicrobial and/or antifungal additives that may include silver and/or zinc.

In another embodiment, the closures of the present invention, including the top wall portion and the annular skirt portion, comprise a plant-based material. In one embodiment, the plant-based material is bamboo. Plant-based materials such as bamboo are other examples of a biosource material that can be used in forming the closures. This is beneficial in that less petroleum-based materials are needed in forming the closure.

The length of the bamboo particles would be of a similar size as the above described wood fillers. The length of the bamboo particles is generally from about 0.02 mm to about 1 mm. More specifically, the length of the bamboo particles is typically from about 0.05 mm to about 0.5 mm, and from about 0.07 mm to about 0.3 mm. The bamboo would typically need further processing such as drying to remove any contained moisture therein.

The mesh size of the sieves or screens of bamboo is typically from about 18 to about 400. A mesh size of 18, for example, will have 18 openings in one linear inch. In other embodiments, the mesh size for the bamboo will be about 20 to about 200, or from about 30 to about 100. In further embodiments, the mesh size for the bamboo is from about 40 to about 100, or from about 50 to about 80.

The closure generally has from about 25 to about 99 wt. % polymeric material and about 1 to about 75 wt. % bamboo. More specifically, the closure generally has from about 50 to about 95 wt. % polymeric material and about 5 to about 50 wt. % bamboo. The closure is from about 50 to about 90 wt. % polymeric material and about 10 to about 50 wt. % bamboo.

More specifically, the closure has from about 60 to about 95 wt. % polymeric material and about 5 to about 40 wt. % bamboo. The closure has from about 60 to about 90 wt. % polymeric material and about 10 to about 40 wt. % bamboo. More specifically, the closure has from about 70 to about 95 wt. % polymeric material and about 5 to about 30 wt. % bamboo. The closure has from about 70 to about 90 wt. % polymeric material and about 10 to about 30 wt. % bamboo. The closure has from about 75 to about 90 wt. % polymeric material and about 10 to about 25 wt. % bamboo. The closure typically has from about 80 to about 90 wt. % polymeric material and about 10 to about 20 wt. % bamboo.

In addition to the polymeric material and the bamboo, additional additives may be used in forming the closures of the present invention. One additive that may be used in an adhesion promoter or compatibilizer to assist in improving the compatibility of the polymeric material and bamboo. One non-limiting example of an adhesion promoter includes, but is not limited to, maleic anhydride modified polyolefin. Another additive that may be added to the polymeric material and the wood filler is a biocide, which assist in preventing or inhibiting the wood filler from degrading. Non-limiting examples of biocides include, but are not limited to, antimicrobial and/or antifungal additives that may include silver and/or zinc.

If a disc is used (e.g., disc 616 of FIGS. 8A, 8B), the disc is also typically made of polymeric material. Non-limiting examples of a polymeric material that may be used in forming the disc include polypropylene (PP), polybutylene terephthalate (PBT) or blends thereof. It is contemplated that the disc may be made of other polymeric materials. If a liner is used (e.g., liner 614 of FIGS. 8A, 8B), it is typically made of polymeric material. Non-limiting examples of a polymeric material that may be used in forming the liner include thermoplastic elastomer (TPE) or blends thereof. It is contemplated that the liner may be made of other polymeric materials

The closures are typically formed by processes such as injection or compression molding, extrusion or the combination thereof.

The containers described above are typically made of polymeric material. One non-limiting example of a material to be used in forming a polymeric container is polyethylene terephthalate (PET), polypropylene (PP) or blends using the same. It is contemplated that the container may be formed of other polymeric or copolymer materials. It is also contemplated that the container may be formed of glass. The container typically has an encapsulated oxygen-barrier layer or oxygen barrier material incorporated therein.

To open the container and gain access to the product therein, the closure (e.g., closures 10, 210 and 610) is unthreaded by turning the closure with respect to the container in one embodiment. To open the container and gain access to the product therein, the closure (e.g., closure 410) is flipped and rotated via the hinge such that the first and second closure portions are opened with respect to each other.

The polymeric closures are desirable in both low-temperature and high-temperature applications. The polymeric closures may be used in low-temperature applications such as an ambient or a cold fill. These applications include water, sports drinks, aseptic applications such as dairy products, and pressurized products such as carbonated soft drinks. It is contemplated that other low-temperature applications may be used with the polymeric closures of the present invention.

The polymeric closures may be exposed to high-temperature applications such as hot-fill, pasteurization, and retort applications. A hot fill application is generally performed at temperatures around 185° F., while a hot-fill with pasteurization is generally performed at temperatures around 205° F. Retort applications are typically done at temperatures greater than 250° F. It is contemplated that the polymeric closures of the present invention can be used in other high-temperature applications.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

What is claimed is:

1. A one-piece closure comprising:
a first closure portion including:
a top wall portion;
an annular skirt portion depending from the top wall portion, the annular skirt portion including an internal thread formation for mating engagement with an external thread formation of a container; and
a second closure portion including:
a tamper-evident band depending from and being partially detachably connected to the annular skirt portion by a first frangible connection,
wherein the closure comprises polymeric material and wood filler.

2. The one-piece closure of claim 1, wherein the top wall portion includes a continuous plug seal depending therefrom and being spaced from an interior surface of the annular skirt portion.

3. The one-piece closure of claim 2, wherein the top wall portion further includes a top seal depending therefrom.

4. The one-piece closure of claim 1, wherein the annular skirt portion further includes a second frangible connection that partially detachably connects to a first section and a second section of the annular skirt portion; and wherein a tether is exposed when the first and second frangible connections are broken.

5. The one-piece closure of claim 1, wherein the one-piece closure is a flip-top closure, the flip-top closure further including a hinge.

6. The one-piece closure of claim 1, wherein the wood filler includes wood flour, wood dust or a combination thereof, the particle size of wood flour or wood dust is from about 0.02 mm to about 1 mm.

7. The one-piece closure of claim 1, wherein the closure comprises from about 1 to about 75 wt. % wood filler, and from about 25 to about 99 wt. % polymeric material.

8. The one-piece closure of claim 7, wherein the closure comprises from about 5 to about 50 wt. % wood filler, and from about 50 to about 95 wt. % polymeric material.

9. The one-piece closure of claim 8, wherein the closure comprises from about 10 to about 50 wt. % wood filler, and from about 50 to about 90 wt. % polymeric material.

10. The one-piece closure of claim 9, wherein the closure comprises from about 10 to about 25 wt. % wood filler, and from about 75 to about 90 wt. % polymeric material.

11. A one-piece closure comprising:
a first closure portion including:
a top wall portion;
an annular skirt portion depending from the top wall portion, the annular skirt portion including an internal thread formation for mating engagement with an external thread formation of a container; and
a second closure portion including:
a tamper-evident band, the tamper-evident band depending from and being partially detachably connected to the annular skirt portion by a first frangible connection, wherein the closure comprises polymeric material and bamboo.

12. The one-piece closure of claim 11, wherein the particle size of bamboo is from about 0.02 mm to about 1 mm.

13. The one-piece closure of claim 11, wherein the closure comprises from about 1 to about 75 wt. % bamboo, and from about 25 to about 99 wt. % polymeric material.

14. The one-piece closure of claim 13, wherein the closure comprises from about 10 to about 25 wt. % bamboo, and from about 75 to about 90 wt. % polymeric material.

15. A package comprising:
a container having a neck portion defining an opening, the container having an external thread formation on the neck portion; and
a one-piece closure being configured for fitment to the neck portion of the container for closing the opening, the closure including a first closure portion and a second closure portion, the first closure portion including a top wall portion and an annular skirt portion depending from the top wall portion, the annular skirt portion including an internal thread formation for mating engagement with an external thread formation of a container, the second closure portion including a tamper-evident band, the tamper-evident band depending from and being partially detachably connected to the annular skirt portion by a first frangible connection,
wherein the closure comprises polymeric material and wood filler.

16. The package of claim 15, wherein the annular skirt portion further includes a second frangible connection that partially detachably connects to a first section and a second section of the annular skirt portion; and wherein a tether is exposed when the first and second frangible connections are broken.

17. The package of claim 15, wherein the one-piece closure is a flip-top closure, the flip-top closure further including a hinge.

18. The package of claim 15, wherein the closure comprises from about 1 to about 75 wt. % wood filler, and from about 25 to about 99 wt. % polymeric material.

19. The package of claim 18, wherein the closure comprises from about 5 to about 50 wt. % wood filler, and from about 50 to about 95 wt. % polymeric material.

20. The package of claim 19, wherein the closure comprises from about 10 to about 50 wt. % wood filler, and from about 50 to about 90 wt. % polymeric material.
